(19) United States
(12) Patent Application Publication
(10) Pub. No.: US 2020/0185765 A1
(43) Pub. Date: Jun. 11, 2020

(54) SULFIDE-BASED SOLID ELECTROLYTE FOR NEGATIVE ELECTRODE OF ALL-SOLID-STATE BATTERY AND METHOD OF MANUFACTURING THE SAME

(71) Applicants: HYUNDAI MOTOR COMPANY, SEOUL (KR); KIA MOTORS CORPORATION, SEOUL (KR)

(72) Inventors: YONG JUN JANG, SEONGNAM-SI (KR); IN WOO SONG, WHASUNG-SI (KR); YUN SUNG KIM, SEOUL (KR); JU YEONG SEONG, HWASEONG-SI (KR)

(73) Assignees: HYUNDAI MOTOR COMPANY, SEOUL (KR); KIA MOTORS CORPORATION, SEOUL (KR)

(21) Appl. No.: 16/431,175

(22) Filed: Jun. 4, 2019

(30) Foreign Application Priority Data
Dec. 10, 2018 (KR) 10-2018-0158185

(51) Int. Cl. H01M 10/0562; H01M 10/058; H01M 4/58

(52) U.S. Cl. CPC H01M 10/0562; H01M 2004/027; H01M 4/5815; H01M 10/058

(57) ABSTRACT

A sulfide-based solid electrolyte which is appropriately usable for a negative electrode of an all-solid-state battery and a method of manufacturing the same, may include a lithium element (Li), a sulfur element (S), a phosphorus element (P), and a halogen element (X), wherein the halogen element (X) is selected from the group consisting of a chlorine element (Cl), a bromine element (Br), an iodine element (I), and combinations thereof, and the molar ratio (S/P) of the sulfur element (S) to the phosphorus element (P) is 5 to 7.

### CROSS-REFERENCE TO RELATED APPLICATION

The present application claims priority to Korean Patent Application No. 10-2018-0158185 filed on Dec. 10, 2018, the entire contents of which is incorporated herein for all purposes by this reference.

### BACKGROUND OF THE INVENTION

### Field of the Invention

The present invention relates to a sulfide-based solid electrolyte which is appropriately usable for a negative electrode of an all-solid-state battery and a method of manufacturing the same.

### Description of Related Art

Secondary batteries have come to be widely used for large-sized devices, such as vehicles and power storage systems, as well as small-sized devices, such as mobile phones, camcorders, and laptop computers.

As devices to which the secondary batteries are applicable are becoming more diverse, the demand for improving the safety and performance of the batteries has increased.

A lithium secondary battery, which is one of the secondary batteries, exhibits higher energy density and capacity per unit area than a nickel-manganese battery or a nickel-cadmium battery.

However, in most cases, a liquid electrolyte, such as an organic solvent, is used in such a lithium secondary battery. For the present reason, the electrolyte may leak from the lithium secondary battery, and the lithium secondary battery may catch fire due to leakage of the electrolyte.

In recent years, therefore, an all-solid-state battery using a solid electrolyte instead of the liquid electrolyte to improve the safety of the lithium secondary battery has attracted considerable attention.

The solid electrolyte exhibits incombustibility or flame retardation. Consequently, the safety of the solid electrolyte is higher than that of the liquid electrolyte. Furthermore, the solid electrolyte may be manufactured to have a bipolar structure. Consequently, it is possible to increase the volumetric energy density of the all-solid-state battery to the extent to which the volumetric energy density of the all-solid-state battery is about 5 times as high as that of a conventional lithium ion battery.

The solid electrolyte is classified as an oxide-based solid electrolyte or a sulfide-based solid electrolyte. The sulfide-based solid electrolyte has higher lithium ionic conductivity than the oxide-based solid electrolyte, and is stable in a larger voltage range. For these reasons, the sulfide-based solid electrolyte is mainly used.

In recent years, research has been actively conducted on a sulfide-based solid electrolyte having an argyrodite-based crystalline structure which is easily compounded and exhibits high ionic conductivity.

However, research on the sulfide-based solid electrolyte is concentrated on improving the physical properties of materials. Since the sulfide-based solid electrolyte constitutes only a component of the all-solid-state battery, there is a necessity for more comprehensive research.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a sulfide-based solid electrolyte having a novel composition which is configured for exhibiting excellent effects when used for a negative electrode of an all-solid-state battery.

The objects of the present invention are not limited to those described above. The objects of the present invention will be clearly understood from the following description and could be implemented by means defined in the claims and a combination thereof.

Various aspects of the present invention are directed to providing a sulfide-based solid electrolyte including a lithium element (Li), a sulfur element (S), a phosphorus element (P), and a halogen element (X), wherein the halogen element (X) is selected from the group consisting of a chlorine element (Cl), a bromine element (Br), an iodine element (I), and combinations thereof, and the molar ratio (S/P) of the sulfur element (S) to the phosphorus element (P) is 5 to 7.

The molar ratio (S/P) of the sulfur element (S) to the phosphorus element (P) may be 6 to 7.

The molar ratio (Li/P) of the lithium element (Li) to the phosphorus element (P) may be 3 to 4.

The sulfide-based solid electrolyte may be represented by Chemical Formula 1 below.

LiₐPS_{b}X_{c} [Chemical Formula 1]

Wherein 3≤a≤4, 5≤b≤7, and 1≤c≤2.

The sulfide-based solid electrolyte may include a negative ion cluster of P₂S₇⁴⁻.

Various aspects of the present invention are directed to providing an all-solid-state battery including a positive electrode, a negative electrode, and a solid electrolyte layer disposed between the positive electrode and the negative electrode, wherein the negative electrode may include the sulfide-based solid electrolyte.

Various aspects of the present invention are directed to providing a method of manufacturing a sulfide-based solid electrolyte, the method including preparing a raw material including simple-substance lithium, simple-substance sulfur, P₂S₅, and lithium halide (LiX), introducing the raw material into a solvent and stirring a mixture, drying the stirred mixture, and thermally treating the dried material.

The sulfide-based solid electrolyte may include a sulfur element (S) derived from at least one selected from the group consisting of the simple-substance sulfur, P₂S₅, and a combination thereof.

The raw material may further include at least one selected from the group consisting of a Li2S, a simple-substance phosphorus, a simple-substance halogen molecule, and combinations thereof.

The step of preparing the raw material may include admixing a simple-substance lithium, a simple-substance sulfur, a P₂S₅, and a lithium halide (LiX) according to the composition of a sulfide-based solid electrolyte represented by Chemical Formula 1 above.

The solvent may be selected from the group consisting of methanol, ethanol, propanol, butanol, dimethyl carbonate, ethyl acetate, tetrahydrofuran, 1,2-dimethoxyethane, propylene glycol dimethyl ether, acetonitrile, and combinations thereof.

The drying step may include performing vacuum drying under conditions of 25 to 200° C. and 2 to 20 hours.

The drying step may include a first drying performed under conditions of 25 to 45° C. and 1 to 3 hours, a second drying performed under conditions of 50 to 70° C. and 1 to 3 hours, a third drying performed under conditions of 100 to 120° C. and 1 to 3 hours, a fourth drying performed under conditions of 150 to 170° C. and 1 to 3 hours, and a fifth drying performed under conditions of 200 to 220° C. and 1 to 3 hours.

The thermal treatment step may be performed under conditions of 400 to 600° C. and 1 to 10 hours.

Other aspects and exemplary embodiments of the present invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a sectional schematic view showing an all-solid-state battery according to an exemplary embodiment of the present invention;

FIG. 2 is a flowchart schematically showing a method of manufacturing a sulfide-based solid electrolyte according to an exemplary embodiment of the present invention;

FIG. 3 is a graph showing the results of measurement of the discharge capacity of an all-solid-state battery according to Experimental Example 2; and

FIG. 4 is a graph showing the results of analysis of a sulfide-based solid electrolyte according to Example using X-ray photoelectron spectroscopy (XPS).

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

The objects described above, and other objects, features and advantages will be clearly understood from the following exemplary embodiments with reference to the annexed drawings. However, the present invention is not limited to the embodiments, and may be embodied in different forms. The exemplary embodiments are suggested only to offer thorough and complete understanding of the disclosed contents and sufficiently inform those skilled in the art of the technical concept of the present invention.

It will be understood that the terms “comprises”, “has” and the like, when used in the exemplary embodiment, specify the presence of stated features, numbers, steps, operations, elements, components or combinations thereof, but do not preclude the presence or addition of one or more other features, numbers, steps, operations, elements, components, or combinations thereof.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For the present reason, it may be understood that, in all cases, the term “about” may be understood to modify all numbers, figures and/or expressions. Furthermore, when numeric ranges are included in the description, these ranges are continuous and include all numbers from the minimum to the maximum including the maximum within the range unless otherwise defined. Furthermore, when the range refers to an integer, it may include all integers from the minimum to the maximum including the maximum within the range, unless otherwise defined.

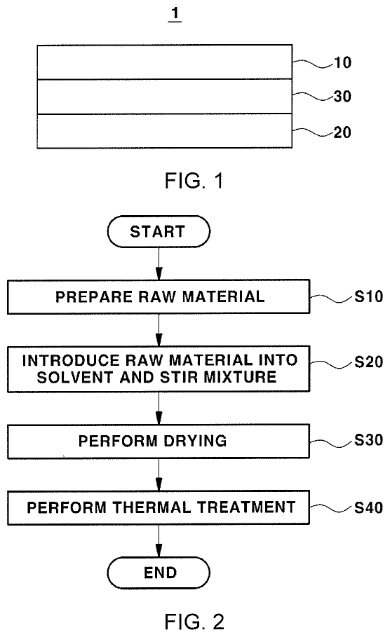

FIG. 1 is a sectional schematic view showing an all-solid-state battery 1 according to an exemplary embodiment of the present invention. Referring to the present figure, the all-solid-state battery 1 includes a positive electrode 10, a negative electrode 20, and a solid electrolyte layer 30 disposed between the positive electrode 10 and the negative electrode 20.

A lithium ion battery, which utilizes a liquid electrolyte, can use only one kind of electrolyte. Since the all-solid-state battery 1 utilizes a solid electrolyte, however, different electrolytes may be used for the positive electrode 10, the negative electrode 20, and the solid electrolyte layer 30. In the case in which a specific solid electrolyte optimized for conditions or physical properties necessary for each component is used, therefore, the performance of the all-solid-state battery 1 may be further improved.

Various aspects of the present invention are directed to providing a sulfide-based solid electrolyte which is capable of increasing the discharge capacity and charging efficiency of the battery when used for the negative electrode 20. However, the sulfide-based solid electrolyte according to an exemplary embodiment of the present invention is not used only for the negative electrode 20, but may also be used for the positive electrode 10 and the solid electrolyte layer 30 without limitation.

The sulfide-based solid electrolyte according to an exemplary embodiment of the present invention includes a lithium element (Li), a sulfur element (S), a phosphorus element (P), and a halogen element (X). The halogen element (X) may be selected from the group consisting of a chlorine element (Cl), a bromine element (Br), an iodine element (I), and combinations thereof.

The sulfide-based solid electrolyte may be represented by Chemical Formula 1 below.

LiₐPS_{b}X_{c} [Chemical Formula 1]

wherein 3≤a≤4, 5≤b≤7, and 1≤c≤2.

The sulfide-based solid electrolyte is characterized in that the molar ratio (S/P) of the sulfur element (S) to the phosphorus element (P) is 5 to 7, preferably 6 to 7.

Furthermore, the sulfide-based solid electrolyte is characterized in that the molar ratio (Li/P) of the lithium element (Li) to the phosphorus element (P) is 3 to 4.

The sulfide-based solid electrolyte has a novel composition in which the molar ratio (S/P) of the sulfur element to the phosphorus element is higher and the molar ratio (Li/P) of the lithium element to the phosphorus element is lower than a conventional sulfide-based solid electrolyte such as Li₆PS₅Cl.

Only in the case in which the molar ratios of the elements of the sulfide-based solid electrolyte satisfy the above ranges, it is possible to increase the discharge capacity and charging efficiency of the all-solid-state battery when the sulfide-based solid electrolyte is used for the negative electrode of the battery.

FIG. 2 is a flowchart schematically showing a method of manufacturing a sulfide-based solid electrolyte according to an exemplary embodiment of the present invention. Referring to the present figure, the method of manufacturing the sulfide-based solid electrolyte includes a step of preparing a raw material including simple-substance lithium, simple-substance sulfur, P₂S₅, and lithium halide (LiX) (S10), a step of introducing the raw material into a solvent and stirring the mixture (S20), a step of drying the stirred mixture (S30), and a step of thermally treating the dried material (S40).

The raw material is characterized in that the raw material includes simple-substance lithium and simple-substance sulfur. In the exemplary embodiment, “simple substance” means a substance that consists of a single element and thus exhibits the inherent chemical properties thereof. Consequently, simple-substance lithium is a substance that consists of only a lithium element and thus exhibits the inherent chemical properties thereof, and simple-substance sulfur is a substance that consists of only a sulfur element and thus exhibits the inherent chemical properties thereof.

As described above, in the sulfide-based solid electrolyte, the molar ratio (S/P) of the sulfur element (S) to the phosphorus element (P) is 5 to 7, preferably 6 to 7, which is higher than in a conventional sulfide-based solid electrolyte. To manufacture the sulfide-based solid electrolyte described above, the present invention is characterized in that simple-substance sulfur is further used as the raw material, in addition to P₂S₅.

Consequently, the sulfur element included in the sulfide-based solid electrolyte derived from a sulfide source selected from the group consisting of simple-substance sulfur, P₂S₅, and a combination thereof.

The raw material may further include at least one selected from the group consisting of a Li2S, a simple-substance phosphorus, a simple-substance halogen molecule, and combinations thereof. To easily compound a sulfide-based solid electrolyte having a specific composition, simple-substance elements may be used instead of compounds.

The step of preparing the raw material may include admixing a simple-substance lithium, a simple-substance sulfur, a P₂S₅, and a lithium halide (LiX) according to the composition of the sulfide-based solid electrolyte represented by Chemical Formula 1 above.

Subsequently, the prepared raw material is introduced into a solvent, and the mixture is stirred (S20).

Any solvent may be used without limitation, as long as the solvent is capable of dissolving the raw material. For example, the solvent may be selected from the group consisting of methanol, ethanol, propanol, butanol, dimethyl carbonate, ethyl acetate, tetrahydrofuran, 1,2-dimethoxyethane, propylene glycol dimethyl ether, acetonitrile, and combinations thereof.

When the raw material is introduced into the solvent and then the mixture is stirred, the raw material is dissolved in the solvent, and the ingredients of the raw material react with each other, whereby a sulfide-based solid electrolyte is compounded. The stirring conditions are not particularly restricted. Stirring may be performed under conditions of a stirring speed and stirring time required for the raw material to be sufficiently dissolved in the solvent.

The step of drying the stirred mixture (S30) is a step of removing the solvent.

The drying step (S30) may be performed under conditions in which the sulfide-based solid electrolyte, compounded at the stirring step (S20), is not deteriorated. For example, vacuum drying may be performed under conditions of 25 to 200° C. and 2 to 20 hours. Vacuum drying is preferably performed to prevent the sulfide-based solid electrolyte from reacting with external moisture.

The drying step (S30) may include a first drying performed under conditions of 25 to 45° C. and 1 to 3 hours, a second drying performed under conditions of 50 to 70° C. and 1 to 3 hours, a third drying performed under conditions of 100 to 120° C. and 1 to 3 hours, a fourth drying performed under conditions of 150 to 170° C. and 1 to 3 hours, and a fifth drying performed under conditions of 200 to 220° C. and 1 to 3 hours. The drying step may be continuously performed from the a first drying to the fifth drying. Since drying is performed while the temperature is gradually increased, it is possible to more rapidly and effectively remove the solvent.

The step of thermally treating the dried material (S40) is a step of growing a crystalline phase of the sulfide-based solid electrolyte. At the stirring step (S20) and the drying step (S30), the sulfide-based solid electrolyte is amorphous. When the amorphous sulfide-based solid electrolyte is thermally treated, it is possible to obtain a crystalline sulfide-based solid electrolyte having an argyrodite-based crystalline structure.

The thermal treatment step (S40) may be performed under conditions of 400 to 600° C. and 1 to 10 hours. When the thermal treatment conditions are the same as above, the crystalline phase of the sulfide-based solid electrolyte may be sufficiently grown while the amorphous sulfide-based solid electrolyte is not deteriorated.

Hereinafter, the present invention will be described in more detail with reference to a concrete example. However, the following example is merely an illustration to assist in understanding the present invention, and the present invention is not limited by the following example.

### Example—Composition of Li_{3.5}PS₇Br

(S10) simple-substance lithium (powder), simple-substance sulfur (powder), P₂S₅, and LiBr (products of Sigma-Aldrich Company) were weighed to prepare a raw material such that the sulfide-based solid electrolyte that was finally obtained had the composition of Example, shown in Table 1 below.

(S20) The raw material was introduced into acetonitrile (a solvent), and the mixture was stirred.

(S30) The stirred mixture was vacuum-dried at about 200° C. for about 2 hours to remove the solvent.

(S40) The dried material was thermally treated at about 550° C. for about 5 hours to obtain a crystallized sulfide-based solid electrolyte.

### Comparative Example—Composition of Li₆PS₅Br

A sulfide-based solid electrolyte was manufactured using the same method as in Example except that Li₂S, P₂S₅, and LiBr (products of Sigma-Aldrich Company) were weighed to prepare a raw material such that the sulfide-based solid electrolyte that was finally obtained had the composition of Comparative Example, shown in Table 1 below.

### Experimental Example 1—Evaluation of Ionic Conductivity and Electronic Conductivity

The ionic conductivity and the electronic conductivity of each of the sulfide-based solid electrolytes according to Example and Comparative Example were measured. Each of the sulfide-based solid electrolytes was compressed to form a sample for measurement (having a diameter of 13 mm and a thickness of 0.6 mm). An alternating-current potential of 10 mV was applied to the sample, and then a frequency sweep of 1×10⁶ to 100 Hz was performed to measure an impedance value, from which ionic conductivity and electronic conductivity were determined. The results are shown in Table 1.

Referring to Table 1, it may be seen that the sulfide-based solid electrolyte according to Example exhibited ionic conductivity equivalent to that of the conventional solid electrolyte and exhibited much higher electronic conductivity than the conventional solid electrolyte.

### Experimental Example 2—Evaluation of Discharge Capacity and Charging Efficiency

A cell for evaluation was manufactured as follows using each of the sulfide-based solid electrolytes according to Example and Comparative Example.

(Formation of negative electrode) A negative electrode slurry, including a negative electrode active material, a solid electrolyte, a conductive agent, and a binder at a weight ratio of 50:40:5:5, was prepared. Graphite (Hitachi Company, 23 μm) was used as the negative electrode active material, the sulfide-based solid electrolyte was used as the solid electrolyte, Super C (Timcal Company, 40 nm) was used as the conductive agent, and an acryl-based binder (Zeon Company, Model Name: SX-9334) was used as the binder.

7.2 g of the negative electrode slurry was applied to a substrate using a doctor blade coating method and was then dried using an oven in a glove box to manufacture a negative electrode.

(Formation of solid electrolyte layer) A solid electrolyte layer slurry, including a solid electrolyte and a binder at a weight ratio of 97:3, was prepared. The sulfide-based solid electrolyte was used as the solid electrolyte, and an acryl-based binder (Zeon Company, Model Name: SX-9334) was used as the binder.

6.8 g of the solid electrolyte layer slurry was applied to the negative electrode using a doctor blade coating method to have a thickness of about 500 μm and was then dried to manufacture a negative electrode-solid electrolyte layer complex. All of the above processes were performed in a glove box.

(Formation of all-solid-state battery) First, the negative electrode-solid electrolyte layer complex was punched to have a size of 150 to prepare a composite negative electrode. A 14Ø Li—In electrode (opposite electrode of the negative electrode) was placed on a 22Ø mold, and the composite negative electrode was placed thereon such that a current collector thereof faced upwards. Subsequently, the mold was coupled, and pressing was performed using a pelletizer to obtain a cell.

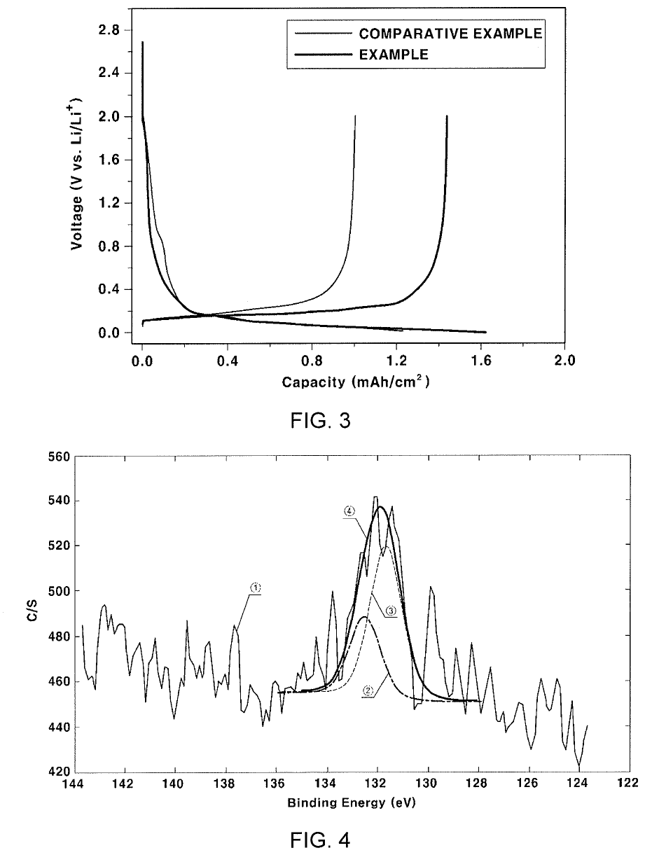

Charging and discharging tests were performed on the cell. Specifically, charging was performed under a condition of CC-CV, and discharging was performed under a condition of CC. Evaluation was performed for voltages of −0.62 to 1.38V. In the constant current mode, the amount of current was 40 μA/cell, and the tests were performed until the constant voltage was reduced to about 20% of the existing amount of current (40 μA/cell). The results are shown in FIG. 3 and Table 1.

TABLE 1

| | | Ionic | Electronic | Discharge | |
|---|---|---|---|---|---|
| | | conductivity | conductivity | capacity | Charging |
| Classification | Composition | [S/cm] | [S/cm] | [mAh/g] | efficiency |
| Example | Li_{3.5}PS₇Br | 1.1 × 10⁻³ | 6.0 × 10⁻⁸ | 241 | 89% |
| Comparative | Li₆PS₅Br | 1.6 × 10⁻³ | 1.5 × 10⁻⁸ | 170 | 82% |
| Example | | | | | |

“Charging efficiency” means the ratio of the discharged amount of electricity to the charged amount of electricity during one cycle of charging and discharging. The charging efficiency may be determined using the following equation.

Charging efficiency [%]=discharged amount of electricity/charged amount of electricity×100

It can be seen from the above results that, in the case in which the sulfide-based solid electrolyte according to an exemplary embodiment of the present invention was used for the negative electrode, the discharge capacity was about 40% higher than for the conventional solid electrolyte, and the charging efficiency was about 8% higher than for the conventional solid electrolyte.

### Experimental Example 3—Evaluation Using X-Ray Photoelectron Spectroscopy (XPS)

The sulfide-based solid electrolyte according to Example was analyzed using X-ray photoelectron spectroscopy. The results are shown in FIG. 4.

Referring to the present figure, peaks were found when the binding energy was about 131.72 eV(\textcircled{3}) and 132.9 eV(\textcircled{2}). Therefore, it may be seen that the sulfide-based solid electrolyte according to an exemplary embodiment of the present invention included a negative ion cluster of P₂S₇⁴⁻.

As is apparent from the foregoing, it is possible to greatly increase the discharge capacity of an all-solid-state battery in the case in which the sulfide-based solid electrolyte according to an exemplary embodiment of the present invention is used for a negative electrode of the all-solid-state battery.

The effects of the present invention are not limited to those mentioned above. It may be understood that the effects of the present invention include all effects which may be inferred from the foregoing description of the present invention.

The present invention has been described in detail with reference to exemplary embodiments thereof. However, it will be appreciated by those skilled in the art that changes may be made in these embodiments without departing from the principles and spirit of the present invention, the scope of which is defined in the appended claims and their equivalents.

What is claimed is:

1. A sulfide-based solid electrolyte comprising:
a lithium element (Li), a sulfur element (S), a phosphorus element (P), and a halogen element (X),
wherein the halogen element (X) is selected from the group consisting of a chlorine element (Cl), a bromine element (Br), an iodine element (I), and combinations thereof, and
wherein a molar ratio (S/P) of the sulfur element (S) to the phosphorus element (P) is 5 to 7.

2. The sulfide-based solid electrolyte of claim 1, wherein the molar ratio (S/P) of the sulfur element (S) to the phosphorus element (P) is 6 to 7.

3. The sulfide-based solid electrolyte of claim 1, wherein a molar ratio (Li/P) of the lithium element (Li) to the phosphorus element (P) is 3 to 4.

4. The sulfide-based solid electrolyte of claim 1, wherein the sulfide-based solid electrolyte is represented by a chemical formula of:
LiₐPS_{b}X_{c}
wherein 3≤a≤4, 5≤b≤7, and 1≤c≤2.

5. The sulfide-based solid electrolyte of claim 1, wherein the sulfide-based solid electrolyte comprises a negative ion cluster of P₂S₇⁴⁻.

6. An all-solid-state battery comprising:
a positive electrode;
a negative electrode; and
a solid electrolyte layer disposed between the positive electrode and the negative electrode,
wherein the negative electrode comprises the sulfide-based solid electrolyte of claim 1.

7. An all-solid-state battery comprising:
a positive electrode;
a negative electrode; and
a solid electrolyte layer disposed between the positive electrode and the negative electrode,
wherein the positive electrode comprises the sulfide-based solid electrolyte of claim 1.

8. An all-solid-state battery comprising:
a positive electrode;
a negative electrode; and
a solid electrolyte layer disposed between the positive electrode and the negative electrode,
wherein the solid electrolyte layer comprises the sulfide-based solid electrolyte of claim 1.

9. A method of manufacturing a sulfide-based solid electrolyte, the method comprising:
preparing a raw material including simple-substance lithium, simple-substance sulfur, P₂S₅, and lithium halide (LiX);
introducing the raw material into a solvent and stirring a mixture of the raw material and the solvent for dissolving the raw material;
drying the stirred mixture; and
thermally treating the dried material,
wherein the sulfide-based solid electrolyte comprises a sulfur element (S) derived from at least one selected from the group consisting of the simple-substance sulfur, the P₂S₅, and a combination thereof, and
wherein a molar ratio (S/P) of the sulfur element (S) to a phosphorus element (P) is 5 to 7.

10. The method of claim 9, wherein the molar ratio (S/P) of the sulfur element (S) to the phosphorus element (P) is 6 to 7.

11. The method of claim 9, wherein the raw material further comprises at least one selected from the group consisting of a Li2S, a simple-substance phosphorus, a simple-substance halogen molecule, and combinations thereof.

12. The method of claim 9, wherein the sulfide-based solid electrolyte comprises a negative ion cluster of P₂S₇⁴⁻.

13. The method of claim 9, wherein preparing the raw material comprises admixing a simple-substance lithium, a simple-substance sulfur, a P₂S₅, and a lithium halide (LiX) according to a composition of the sulfide-based solid electrolyte represented by a chemical formula of:
LiₐPS_{b}X_{c}
wherein 3≤a≤4, 5≤b≤7, and 1≤c≤2.

14. The method of claim 9, wherein the solvent is selected from the group consisting of methanol, ethanol, propanol, butanol, dimethyl carbonate, ethyl acetate, tetrahydrofuran, 1,2-dimethoxyethane, propylene glycol dimethyl ether, acetonitrile, and combinations thereof.

15. The method of claim 9, wherein the drying of the stirred mixture includes performing vacuum drying under conditions of 25 to 200° C. and 2 to 20 hours.

16. The method of claim 9, wherein the drying of the stirred mixture includes:
a first drying performed under conditions of 25 to 45° C. and 1 to 3 hours;
a second drying performed under conditions of 50 to 70° C. and 1 to 3 hours;
a third drying performed under conditions of 100 to 120° C. and 1 to 3 hours;
a fourth drying performed under conditions of 150 to 170° C. and 1 to 3 hours; and
a fifth drying performed under conditions of 200 to 220° C. and 1 to 3 hours.

17. The method of claim 9, wherein the thermally treating of the dried material is performed under conditions of 400 to 600° C. and 1 to 10 hours.
